(19) United States
(12) Patent Application Publication
(10) Pub. No.: US 2010/0139607 A1
(43) Pub. Date: Jun. 10, 2010

(54) WET CYLINDER SLEEVE HAVING A CAVITATION-RESISTANT SURFACE

(76) Inventors: Christian Herbst-Dederichs, Bornheim (DE); Michael Buchmann, Stuttgart (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/441,955

(22) PCT Filed: Jun. 18, 2007
(86) PCT No.: PCT/EP2007/005355

§ 371 Date: Jan. 28, 2010

(30) Foreign Application Priority Data
Sep. 11, 2006 (DE) 10 2006 042 549.9

(51) Int. Cl. F02F 1/16; C23C 4/08; C23C 4/16; C23C 4/10; C23C 4/02; F01P 3/02

(52) U.S. Cl. 123/193.2; 427/456; 427/449; 427/453; 427/447; 123/41.72

(57) ABSTRACT

A wet cylinder liner, which exhibits a cast basic body comprised of a cast iron alloy, has at least one outer surface area of which exhibits a thermal injection layer consisting of a basic iron alloy as a coating, with a layer thickness of 1 μm to 1000 μm.

The present invention relates to wet cylinder liners made of a cast iron alloy for internal combustion engines or piston engines, and to a method for manufacturing the aforementioned cylinder linings and its use. In particular, the invention relates to wet cylinder linings of the kind used in NKW engines.

Cylinder linings are normally made out of gray cast iron, in part out of vermicular casting, but also can be made out of steel. The engine block of internal combustion engines or piston engines usually consists of a cast iron or aluminum alloy, cast materials, steel or light metal. Wear-resistant metals or metal alloys are used as cylinder lining materials. For example, DE 100 19 793 C1 describes the manufacture of thermally injected cylinder linings made of steel or aluminum or silicon alloys.

The purpose of the cylinder lining is to minimize wear between piston rings and the cylinder wall, divert heat of combustion and improve the mechanical stability of the system during operation. Aluminum-silicon cylinder linings (Silitec®) or [cylinder linings] made of block alloys (Alusil®, Lokasil®) have a high thermal conductivity. However, given the high mechanical loads in new motors with direct fuel injection, the mechanical strength values for conventional aluminum-silicon alloys are at the load limit.

DE 196 05 946 C1 discloses a method for manufacturing cylinder liners, with which a cylinder liner with a high wear resistance can be easily and cost effectively manufactured with an optimal thin wall thickness, and then be used as a separate component in an engine block.

The outside of wet cylinder liners, which are often used in NKW engines, exhibits cavitation that can impair engine function depending on scope. With respect to the cavitation on the surface of cylinder linings on the side exposed to water, it is assumed that the secondary piston movement induces an oscillation of the cylinder wall, so that the local pressure of the water on the surface fluctuates cyclically. If a critical amplitude and frequency are now reached, the pressure is reduced so quickly that the vapor pressure of the water is locally exceeded, and a vapor bubble forms on the metal surface. In the ensuing moment as the wall oscillates back, the pressure again rises to exceed the vapor pressure, and the vapor bubble bursts explosively. These microscopic explosions generate a lot of wear on the cylinder wall exposed to water.

In prior art, various measures are taken in an effort to minimize this wear. For example, additives are incorporated into the coolant to positively influence the vapor pressure of the coolant. However, the disadvantage to this is that the motor operator must always refill precisely this agent, which cannot be guaranteed in global traffic. Another measure is to optimize the piston, in particular lower the piston installation clearance. However, this results in an increased tendency of corrosion. In addition, the tighter tolerances are cost intensive. Further, attempts are made to increase the modulus of elasticity for the cylinder material, e.g., by using a vermicular casting or steel. But these options are both extremely cost intensive. Plasma coating the outside of the liner with a NiCrAlY material is also associated with considerable costs.

Therefore, the object of the present invention is to find a cost-effective material combination that combines the complex tasks of a wet cylinder liner, in particular those involving installation as a non-cast cylinder liner in piston motors, with respect to the mechanics, tribology on the inside, e.g., friction, smearing and wear, and cavitation on the outside.

This object is achieved by a cylinder liner according to claim 1, a method according to claim 25, as well as an application according to claim 53.

The subclaims contain advantageous embodiments of the invention.

A cylinder liner according to the invention consists of a cast basic body comprised of a cast iron alloy, at least one outer surface area of which exhibits a thermal injection layer consisting of a basic iron alloy as a coating, with a layer thickness of 1 μm to 1000 μm. If required by the application in the motor, the cylinder liner is not coated exclusively in the coolant area, but rather the coated area is lengthened up to the bond of the cylinder liner. This is necessary in cases where cavitation is also to be expected between the upper two O-rings.

The thermal injection process for applying the coating preferably involves electric arc spraying, wherein use is preferably made of argon, helium, hydrogen, nitrogen, compressed air or a mixture thereof as the atomizing gas.

The coating is preferably applied as a wire material. The wire material is a solid wire in one embodiment. The wire material is a filler wire in another embodiment.

As an option, the coating is subsequently smoothed, e.g., via grinding, lathing or shot peening.

The coating exhibits a hardness of 200-500 HV1 in one embodiment.

The coating optionally contains oxides, preferably in a concentration of 1 to 20% v/v.

In one embodiment, the coating exhibits a roughness Rz according to DIN EN ISO 4288 of greater than 130 μm.

In one embodiment, the iron alloys are selected from the group consisting of FeCr and FeNi. In like manner, the basic iron alloy coating material can be selected from the group consisting of unalloyed or alloyed carbon steels, wherein the carbon content in the carbon steel preferably measures between 0.2 and 1.5% w/w, preferably 0.5 to 1.5% w/w, and especially preferred 0.7 to 0.9% w/w.

The basic iron alloy can optionally contain chromium in a concentration of 1 to 25% w/w. In addition, the basic iron alloy can contain nickel in a concentration of 1 to 25% w/w. In like manner, the basic iron alloy can contain cobalt in a concentration of 1 to 25% w/w. The basic iron alloy can contain copper in a concentration of 1 to 10% w/w. In one embodiment, the basic iron alloy contains aluminum in a concentration of 1 to 10% w/w. Yttrium can optionally be incorporated in a concentration of 0 to at most 2% w/w. If the basic iron alloy contains two or more of the elements chromium, nickel, cobalt, copper, aluminum and yttrium, the sum total of the concentrations of these alloy elements measures at most 45% w/w, preferably 35% w/w, and especially preferred 25% w/w.

In a preferred embodiment, the coating is subsequently sealed by means of inorganic or organic materials.

In another preferred embodiment, the cylinder liner is a pretreated cylinder liner. The pretreatment preferably involves sandblasting.

The above object is further achieved by a method for applying a coating to at least one outer surface area of a work piece with a cast basic body consisting of a cast iron alloy, in particular a wet cylinder liner, wherein the method encompasses the following step:

Application of a thermal injection layer consisting of a basic iron alloy as the coating to the at least one outer surface area, wherein the layer thickness measures 1 to 1000 μm, preferably 100 to 300 μm. In an embodiment, the thermal injection method involves electric arc wire spraying.

The coating material preferably consists of the materials specified above. In one embodiment, the coating material is a wire, thereby ensuring a complete melting of the material, as opposed to the powdery parent materials. The wire material is preferably a solid wire. It is also preferred that the wire material be a filler wire.

The coating exhibits a hardness of 200 to 500 HV1 in one embodiment.

The coating can optionally contain oxides, preferably 1 to 20% v/v.

In another embodiment, the coating has a roughness Rz according to DIN EN ISO 4288 of greater than 130 μm.

As an option, the work piece is pretreated in a preceding step. Pretreatment can involve sandblasting, optionally followed by oil-free high-pressure sandblasting. Sandblasting can involve the use of coarse chips. Pretreatment can also take place by means of etching using at least one halogen-containing solvent, such as Freon.

In one embodiment, the applied coating is smoothened, e.g., by means of grinding, lathing or shot peening.

In one embodiment, the coating is subsequently sealed by means of inorganic or organic materials.

In order to implement the method according to the invention, use can be made of any cylinder liner with a cast basic body comprised of a cast iron alloy. Use is preferably made of cylinder liners made of GJL, GJV, GJS or cast steel. GJV is cast iron with a vermicular graphite structure. GJS is cast iron with a “spherical” graphite structure. GJL is cast iron with a lamellar graphite structure.

The drawing shows:

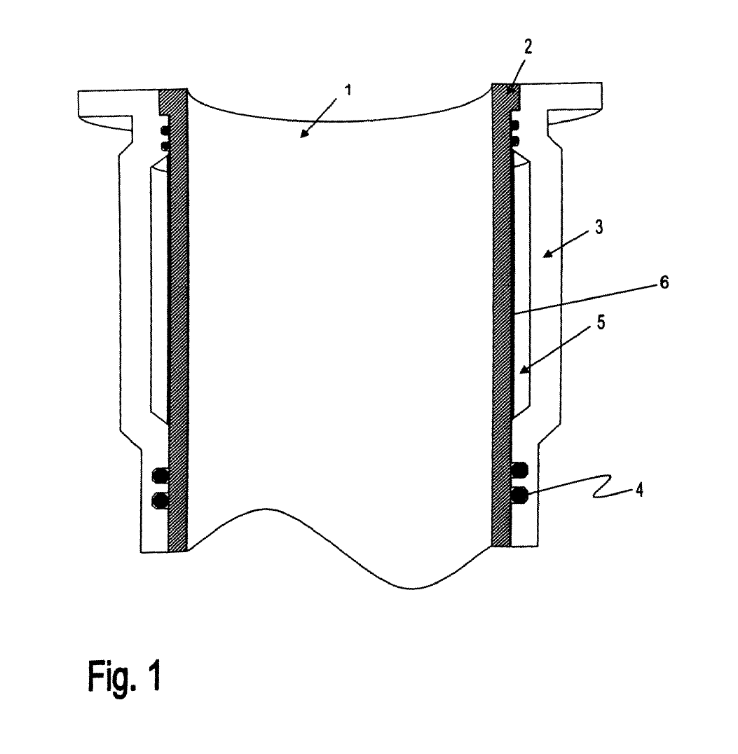

FIG. 1: A section through an exemplary wet cylinder liner (2) with cylinder face (1) in a cylinder (3). The coolant area (5) is sealed by means of gaskets, O-rings (4). The cylinder liner (2) is provided with a coating (6) in at least one outer region according to the invention.

The invention will now be described in greater detail based on the attached example, without being limited to the latter in any way.

### EXAMPLE 1 (ACCORDING TO THE INVENTION)

A cylinder liner with cast basic body comprised of a cast iron alloy is pretreated via sandblasting. A wire unalloyed steel with a carbon percentage of 0.8% w/w is then applied to the outside at the critical areas sensitive to cavitation in an electric arc injection process with nitrogen as the atomizing gas. The layer thickness of the coating averages 250 μm after grinding.

### EXAMPLE 2 (ACCORDING TO THE INVENTION)

A cylinder liner with cast basic body comprised of a cast iron alloy is pretreated via sandblasting. A wire steel with a nickel percentage of 14% w/w and a carbon percentage of 0.7% w/w is then applied to the outside at the critical areas sensitive to cavitation until the cylinder liner bonds in an electric arc injection process with nitrogen as the atomizing gas. The layer thickness of the coating averages 300 μm after shot peening.

The cylinder liner according to the invention has optimal surface properties, so that it resists wear caused by cavitation or reduces it to a tolerable level.

1. A wet cylinder liner having a cast basic body comprised of a cast iron alloy, at least one outer surface area of which exhibits a thermal injection layer consisting of a basic iron alloy as the coating with a layer thickness of 1 μm to 1000 μm.

2. The wet cylinder liner according to claim 1, wherein the coating has a hardness of 200 to 500 HV1.

3. The wet cylinder liner according claim 1, wherein the coating contains oxides.

4. The wet cylinder liner according to claim 3, wherein the coating contains 1 to 20% v/v oxides.

5. The wet cylinder liner according to claim 1, wherein the coating has a roughness Rz of 130 μm.

6. The wet cylinder liner according to claim 1, wherein the coating comprises a wire material applied via thermal injection.

7. The wet cylinder liner according to claim 6, wherein a wire material comprises a solid wire.

8. The wet cylinder liner according to claim 6, wherein a wire material comprises a filler wire.

9. The wet cylinder liner according to claim 1, wherein the coating has a surface finish prepared by one of grinding, lathing and shot peening.

10. The wet cylinder liner according to claim 6, wherein the thermal injection comprises electric arc spraying.

11. The wet cylinder liner according to claim 1, wherein the basic iron alloy coating material is selected from the group consisting of unalloyed carbon steels.

12. The wet cylinder liner according to claim 11, wherein the carbon content of the carbon steel lies between 0.2 and 1.5% w/w.

13. The wet cylinder liner according to claim 12, wherein the carbon content of the carbon steel lies between 0.5 and 1.5% w/w.

14. The wet cylinder liner according to claim 13, wherein the carbon content of the carbon steel measures 0.7 to 0.9% w/w.

15. The wet cylinder liner according to claim 1, wherein the basic iron alloy contains between 1 and 25% w/w chromium.

16. The wet cylinder liner according to claim 1, wherein the basic iron alloy contains between 1 and 25% w/w nickel.

17. The wet cylinder liner according to claim 1, wherein the basic iron alloy contains between 1 and 25% w/w cobalt.

18. The wet cylinder liner according to claim 1, wherein the basic iron alloy contains between 1 and 10% w/w copper.

19. The wet cylinder liner according to claim 1, wherein the basic iron alloy contains between 1 and 10% w/w aluminum.

20. The wet cylinder liner according to claim 1, wherein the basic iron alloy contains between 0 to at most 2% w/w concentration of yttrium.

21. The wet cylinder liner according to claim 1, wherein the iron alloy is selected from the group consisting of FeCr and FeNi.

22. The wet cylinder liner according to claim 1, wherein the coating is subsequently sealed by means of inorganic or organic materials.

23. The wet cylinder liner according to claim 1, wherein the cylinder liner is a pretreated cylinder liner.

24. The wet cylinder liner according to claim 23, wherein the pretreatment takes place via sandblasting.

25. A method for applying a coating on at least one outer surface area of a wet cylinder liner with a cast basic body comprised of a cast iron alloy, wherein the method involves the following step:
applying a thermal injection layer comprised of a basic iron alloy as the coating to the at least one outer surface area, wherein the layer thickness measures 1 to 1000 μm.

26. The method according to claim 25, wherein a wire material is applied via a thermal injection process.

27. The method according to claim 26, wherein the wire material is a solid wire.

28. The method according to claim 26, wherein the wire material is a filler wire.

29. The method according to claim 26, wherein the thermal injection process involves electric arc wire spraying.

30. The method according to claim 25, wherein the coating exhibits a hardness of 200 to 500 HV1.

31. The method according to claim 25, wherein the coating contains oxides.

32. The method according to claim 31, wherein the coating contains 1 to 20% v/v oxides.

33. The method according to claim 25, wherein the coating exhibits a roughness Rz of greater than 130 μm.

34. The method according to claim 25, wherein the cylinder liner is pretreated.

35. The method according to claim 34, wherein the pretreatment involves sandblasting or etching with at least one halogen-containing solvent.

36. The method according to claim 35, wherein sandblasting is followed by oil-free high-pressure sandblasting.

37. The method according to claim 35, wherein sandblasting is associated with coarse chips

38. The method according to claim 35, wherein the halogen-containing solvent is Freon.

39. The method according to claim 25, wherein the applied coating is subsequently treated by one of grinding, lathing or shot peening.

40. The method according to claim 25, wherein the basic iron alloy coating material is selected from the group consisting of unalloyed carbon steels.

41. The method according to claim 40, wherein the carbon content of the carbon steel lies between 0.2 and 1.5% w/w.

42. The method according to claim 41, wherein the carbon content of the carbon steel lies between 0.5 and 1.5% w/w.

43. The method according to claim 42, wherein the carbon content of the carbon steel lies between 0.7 and 0.9% w/w.

44. (canceled)

45. The method according to claim 25, wherein the basic iron alloy contains between 1 and 25% w/w chromium.

46. The method according to claim 25, wherein the basic iron alloy contains between 1 and 25% w/w nickel.

47. The method according to claim 25, wherein the basic iron alloy contains between 1 and 25% w/w cobalt.

48. The method according to claim 25, wherein the basic iron alloy contains between 1 and 10% w/w copper.

49. The method according to claim 25, wherein the basic iron alloy contains between 1 and 10% w/w aluminum.

50. The method according to claim 25, wherein the basic iron alloy contains between 0 to at most 2% w/w concentration of yttrium.

51. The method according to claim 25, wherein the iron alloy is selected from the group consisting of FeCr and FeNi.

52. The method according to claim 25, wherein the coating is sealed in an additional step by means of inorganic or organic materials.

53. (canceled)
